(19) United States
(12) Patent Application Publication
(10) Pub. No.: US 2025/0361583 A1
(43) Pub. Date: Nov. 27, 2025

(54) EFFICIENT MULTIPHASE-FLOW GRADED-SEPARATION, CONCENTRATION, AND PURIFICATION SYSTEM FOR ARGILLACEOUS SANDSTONE URANIUM ORE

(71) Applicant: INSTITUTE OF ROCK AND SOIL MECHANICS, CHINESE ACADEMY OF SCIENCES, WUHAN (CN)

(72) Inventors: Qiang XUE, WUHAN (CN); Jiangshan LI, WUHAN (CN); Feng ZHONG, WUHAN (CN); Xin CHEN, WUHAN (CN); Yong WAN, WUHAN (CN); Houzhen WEI, WUHAN (CN); Runliang ZHU, WUHAN (CN)

(73) Assignee: INSTITUTE OF ROCK AND SOIL MECHANICS, CHINESE ACADEMY OF SCIENCES, WUHAN (CN)

(21) Appl. No.: 19/296,169

(22) Filed: Aug. 11, 2025

(30) Foreign Application Priority Data
Jan. 9, 2025 (CN) 202510031545.7

(51) Int. Cl. C22B 60/02

(52) U.S. Cl. CPC C22B 60/0208; C22B 60/0221

(57) ABSTRACT

An efficient multiphase-flow graded-separation, concentration, and purification system for argillaceous sandstone uranium ore includes a hydraulic tossing washing and scattering pretreatment device, a high-frequency linear vibration grading device, a first-stage multiphase-flow swirling grading device, an energy-gathering ultrasonic scrubbing device, a second-stage multiphase-flow swirling grading device, a high-frequency linear vibration dewatering device, an efficient uniform-mixing and activating system and a conditioning and pressing dewatering system. The present disclosure implements intensive mud-sand stripping of crushed argillaceous sandstone uranium ore, fine graded-separation of material, and efficient uniform-mixing and activating and deep efficient dewatering of fine-particle argillaceous material. Finally, four types of core material of coarse sand material, fine sand material, dry tailings residue and a high-concentration uranium ore leaching solution are formed through continuous work. Efficient multiphase-flow graded-separation, concentration and purification of the argillaceous sandstone uranium ore are implemented, and an intensive extraction rate of uranium ore resources is improved.

### CROSS-REFERENCE TO RELATED APPLICATION

This application claims priority to Chinese Patent Application No. 202510031545.7 with a filing date of Jan. 9, 2025. The content of the aforementioned application, including any intervening amendments thereto, is incorporated herein by reference.

### TECHNICAL FIELD

The present disclosure relates to the technical field of efficient ore separation and intensive graded-separation of uranium, and in particular to an efficient multiphase-flow material graded-separation, concentration, activation, and purification system for low-grade argillaceous sandstone uranium ore.

### BACKGROUND OF THE INVENTION

The existing conventional ore separation apparatuses with mud-sand separation technology mainly consist of grinding apparatuses and sieving apparatuses. Because the apparatus structure is single and ordinary, only particle diameters can be classified simply, and requirements of efficient and economic separation and extraction of uranium from argillaceous sandstone uranium ore cannot be satisfied. For example, as disclosed in China patent CN112774870A, a separation pretreatment method for argillaceous sandstone-type uranium ore with high acid consumption mainly performs grinding and flotation pretreatment and then classification and ore separation on the argillaceous sandstone-type uranium ore to improve the utilization value of the uranium ore to a certain extent. However, overall grinding results in elevated costs, increased subsequent particle analysis and separation workload, and complex process flows.

Accordingly, for efficient ore separation industry of low-grade argillaceous sandstone uranium ore, it is urgent to break through the technical bottlenecks such as efficient mud-sand stripping separation, directional grading, efficient activation of particle interfaces, and uranium ore concentration and purification of argillaceous sandstone uranium ore in order to improve the development and utilization level of the argillaceous sandstone uranium ore.

### SUMMARY OF THE INVENTION

Aiming at problems that an existing technical apparatus for uranium ore separation has difficulty in mud-sand stripping, and is insufficient in particle grading precision, low in material uniform-mixing and activating degree and low in mud water separation efficiency during argillaceous sandstone uranium ore separation, a high mud content in sand material mud cannot satisfy a heap leaching condition, and mud-sand dewatering cost is high, a technical problem to be solved in the present disclosure is to provide an efficient multiphase-flow graded-separation concentration, purification system for argillaceous sandstone uranium ore. The present disclosure can implement intensive mud-sand stripping of crushed argillaceous sandstone ore material and fine graded-separation of the material, and can also perform efficient uniform-mixing and activating and deep and efficient dewatering for fine-particle argillaceous material, so as to fully improve fine separation efficiency of uranium resources.

A technical solution used by the present disclosure is as follows:

An efficient multiphase-flow graded-separation, concentration and purification system for argillaceous sandstone uranium ore includes a hydraulic tossing washing and scattering pretreatment device, a high-frequency linear vibration grading device, a first-stage multiphase-flow swirling grading device, an energy-gathering ultrasonic scrubbing device, a second-stage multiphase-flow swirling grading device, a high-frequency linear vibration dewatering device, an efficient uniform-mixing and activating system and a conditioning and pressing dewatering system. A discharge port of the hydraulic tossing washing and scattering pretreatment device is in communication with a feed port of the high-frequency linear vibration grading device. A filtering particle diameter of the hydraulic tossing washing and scattering pretreatment device is designed to be N1. Slurry with a particle diameter less than N1 is conveyed to the high-frequency linear vibration grading device. A discharge port of the high-frequency linear vibration grading device is in communication with a feed port of the first-stage multiphase-flow swirling grading device. A sieving particle diameter of the high-frequency linear vibration grading device is designed to be N2. N2<N1. Material with a particle diameter less than N2 is conveyed to the first-stage multiphase-flow swirling grading device. A grading median particle diameter of the first-stage multiphase-flow swirling grading device is designed to be N3. N3<N2. Material with a particle diameter ranging from N3 to N2 is discharged from an outlet at a lower end and guided into the energy-gathering ultrasonic scrubbing device. Fine-particle light material with a particle diameter less than or equal to N3 and a large amount of water are guided to the efficient uniform-mixing and activating system along a central overflow port of a swirling flow field. The energy-gathering ultrasonic scrubbing device is used for stripping and scattering remaining clay particles covering surfaces of sand, to separate mud from the sand. A discharge port of the energy-gathering ultrasonic scrubbing device is in communication with a feed port of the second-stage multiphase-flow swirling grading device. A grading median particle diameter of the second-stage multiphase-flow swirling grading device is designed to be N3. The clay particles with a particle diameter less than or equal to N3 and stripped by the energy-gathering ultrasonic scrubbing device and a large amount of water are guided to the efficient uniform-mixing and activating system along the central overflow port of the swirling flow field. Sand material having a particle diameter between N3 to N2 and formed through mud-sand grading is guided to the high-frequency linear vibration dewatering device. The efficient uniform-mixing and activating system includes a pneumatic-energy miscible-flow uniform-mixing device and a micro-electrolysis activating device. Overflow ports of the first-stage multiphase-flow swirling grading device and the second-stage multiphase-flow swirling grading device are in communication with the pneumatic-energy miscible-flow uniform-mixing device. A discharge port of the pneumatic-energy miscible-flow uniform-mixing device is in communication with the micro-electrolysis activating device. A discharge port of the micro-electrolysis activating device is in communication with the conditioning and pressing dewatering system. The conditioning and pressing dewatering system is used for physically and chemically conditioning and condensing mixed slurry material subjected to chemical leaching, and then performing high-pressure plate-frame pressing dewatering, to implement solid-liquid separation.

In the above solution, the energy-gathering ultrasonic scrubbing device includes a scrubbing cylinder, a reverse stirring system, an energy-gathering ultrasonic vibrator and a slurry storage tank. The scrubbing cylinder is provided with a feed hopper and an overflow residue discharge pipe. The reverse stirring system is arranged in the scrubbing cylinder and includes a rotating shaft and at least four layers of reverse stirring blade structures arranged in an axial direction of the rotating shaft. Each layer of reverse stirring blade structure comprises several blades arranged in a circumferential direction of the rotating shaft. Inclination directions of blades of two adjacent layers of reverse stirring blade structures relative to the rotating shaft are opposite. The energy-gathering ultrasonic vibrator includes an ultrasonic transducer and an energy-gathering vibration transmitting rod. The ultrasonic transducer is fixed outside the scrubbing cylinder. The energy-gathering vibration transmitting rod is connected to the ultrasonic transducer and located inside the scrubbing cylinder. The slurry storage tank is connected to the overflow residue discharge pipe. A discharge port of the overflow residue discharge pipe is directly guided to the slurry storage tank.

In the above solution, an included angle between each blade of the reverse stirring blade structures and the rotating shaft does not exceed 45°.

In the above solution, the energy-gathering vibration transmitting rod is provided with several spherical recesses at intervals in an axial direction of the energy-gathering vibration transmitting rod.

In the above solution, the energy-gathering ultrasonic vibrator has a frequency of 20 KHz to 25 KHz and an amplitude of 80 μm to 100 μm.

In the above solution, the slurry storage tank is arranged at a bottom of the scrubbing cylinder. A cleaning discharge port is arranged at the bottom of the scrubbing cylinder as a shutdown unloading cleaning and draining channel. A gate valve in a normally closed state is arranged at the bottom of the scrubbing cylinder.

In the above solution, the slurry storage tank is provided with a clean water pipe for injecting clean water. The slurry storage tank is further internally provided with a slurry uniform-mixing device. A slurry discharge port and a high-pressure centrifugal slurry pump are arranged at a bottom of the slurry storage tank. The slurry material is lifted and discharged through the high-pressure centrifugal slurry pump.

In the above solution, the scrubbing cylinder is internally provided with a single bin or a plurality of bins according to production capacity requirements. Each bin is provided with one reverse stirring system and the energy-gathering ultrasonic vibrator. When the plurality of bins are provided, an interior of the cylinder is divided into the plurality of bins by arranging middle baffles. Communication channels are reserved at bottoms or tops of the middle baffles for communication between the bins. The communication channels are alternately arranged in a vertical direction to guarantee that the material fully passes through a stirring area.

In the above solution, the pneumatic-energy miscible-flow uniform-mixing device includes a uniform-mixing reaction kettle cylinder, a miscible-flow uniform-mixing spraying device and a high-pressure air supply device. The miscible-flow uniform-mixing spraying device includes a fixed bracket, a miscible-flow uniform-mixing sprayer and a pneumatic-energy distributor. The fixed bracket is fixedly mounted at a bottom of the uniform-mixing reaction kettle cylinder. The miscible-flow uniform-mixing sprayer and the pneumatic-energy distributor are arranged on the fixed bracket separately. An air inlet of the pneumatic-energy distributor is connected to the high-pressure air supply device. An air outlet of the pneumatic-energy distributor is connected to the miscible-flow uniform-mixing sprayer. High-pressure air generated by the high-pressure air supply device enters the miscible-flow uniform-mixing sprayer through the pneumatic-energy distributor. Pneumatic energy is provided by a high-pressure air jet flow in the miscible-flow uniform-mixing sprayer. The high-pressure air jet flow makes contact and gets mixed with mixed slurry in a limited space in a pipe to form miscible-flow material in a relatively low density. The miscible-flow material is rapidly conveyed under action of a continuous pneumatic push force and upward buoyancy, and sprayed and diffused at a high speed from a pipe outlet to drive pulp particles to form a high-speed turbulent flow and mixed flow. The pulp particles and an activator are mixed rapidly. Mutual conversion between the pneumatic energy and mechanical kinetic energy of a miscible flow phase is completed to implement shaftless stirring and uniform mixing.

In the above solution, the miscible-flow uniform-mixing sprayer includes a miscible-flow sprayer, an axial sleeve and a slurry inlet pipe that are coaxially arranged and are in communication with each other. An upper end of the axial sleeve is fixedly connected to the miscible-flow sprayer. A gap is reserved between an inner wall of a lower end of the miscible-flow sprayer and an outer wall of the upper end of the axial sleeve to form a high-pressure air chamber. The high-pressure air chamber is provided with an air inlet connector for being connected to the air outlet of the pneumatic-energy distributor. An area of the miscible-flow sprayer located above the axial sleeve is sequentially provided with a mixed-flow negative pressure area, a multiphase mixed flow lifting area and a diffusion flow outlet from bottom to top. The mixed-flow negative pressure area is in communication with the high-pressure air chamber through a gap channel. A lower end of the axial sleeve is fixedly connected to the slurry inlet pipe. A slurry inlet channel is formed inside the slurry inlet pipe and the axial sleeve.

In the above solution, the slurry inlet pipe is of a horn structure with a lower portion thicker than an upper portion. A diameter D of an upper end of the slurry inlet pipe is equal to an inner diameter of the axial sleeve.

In the above solution, the diameter D of the upper end of the slurry inlet pipe satisfies formula (1):

$$D \leq \sqrt{\frac{{Q}_{m}}{0.75 V}} \qquad ( 1 )$$

where Qₘ is a designed slurry flow rate with a value designed in advance; and V is a lifting flow rate.

In the above solution, the lifting flow rate V is calculated according to formula (2):

$$V > 4 {ω}_{max} \qquad ( 2 )$$

where ωₘₐₓ is a maximum value of a settling rate ω of the pulp particles, and the settling rate ω of the pulp particles is calculated according to formula (5):

$$ω = \sqrt{{( {C}_{1} \frac{μ}{d} )}^{2} + {C}_{2} ( \frac{{ρ}_{s} - ρ}{ρ} ) gd} - {C}_{1} ( \frac{μ}{d} ) \qquad ( 5 )$$

where

$${C}_{1} = \frac{2}{3} ( 40 - 31 {e}^{- 0.0061 Re} ) ,$$

Re is a Reynolds number,

$${C}_{2} = \frac{1}{9} {C}_{1} ,$$

ρₛ is a density of mud-sand particles, ρ is a fluid density, d is a spherical diameter of the mud-sand particles, and μ is a kinematic viscosity coefficient of liquid.

In the above solution, an inner diameter of the mixed-flow negative pressure area of the miscible-flow sprayer is gradually reduced from bottom to top. An inner diameter of the multiphase mixed flow lifting area is kept constant from bottom to top. An inner diameter of the diffusion flow outlet is gradually increased from bottom to top.

In the above solution, the micro-electrolysis activating device includes plate-type micro-electrolysis electrodes, a micro-electrolysis activating reaction tank and a constant current power supply. The plate-type micro-electrolysis electrodes are fixed on two ends of an inner side of the micro-electrolysis activating reaction tank through insulating material. The constant current power supply is arranged on an outer side of the micro-electrolysis activating reaction tank and connected to the plate-type micro-electrolysis electrodes through wires.

In the above solution, the conditioning and pressing dewatering system includes a conditioning and condensing device, a high-pressure plunger grouting device, a high-pressure diaphragm filter press and a high-concentration uranium ore leaching solution collecting device. A feed port of the conditioning and condensing device is in communication with a discharge port of the micro-electrolysis activating device. A discharge port of the conditioning and condensing device is in communication with a feed port of the high-pressure diaphragm filter press through the high-pressure plunger grouting device. The high-concentration uranium ore leaching solution collecting device is used for collecting a high-concentration uranium ore leaching solution from the high-pressure diaphragm filter press.

The present disclosure has the beneficial effects as follows:
1. According to the efficient multiphase-flow graded-separation, concentration, and purification system for argillaceous sandstone uranium ore in the present disclosure, preliminary efficient crushing is performed to crush ore material to 3 mm merely. An ore ball-milling process is omitted. A situation that some ore particles (74 μm to 3 mm) conducive to heap leaching are crushed to increase an amount of ore powder (−74 μm) is avoided. A physical stripping method is used for extreme desliming. Thus a workload of later chemical activation leaching and ore separation is reduced. Efficiency is improved, and cost is reduced.
2. According to the present disclosure, first, the hydraulic tossing washing and scattering pretreatment device is used to scatter mud lumps wrapped by clay particles, and some clay particles are stripped out, so as to reduce the workload of later ultrasonic washing and improve efficiency. The two stages of multiphase-flow swirling grading devices are used, such that a grading ability and effect are greatly increased, and a mud content in sand particles is greatly reduced. The mud content is less than 3%, which is far lower than the existing level of the industry. The energy-gathering ultrasonic scrubbing device is used to efficiently strip and scatter clay particles remaining on surfaces of the sand particles, such that a technical problem of mud and sand stripping and separation in the industry is solved, the mud content of the particles is reduced, and high-quality sand ore is provided for heap leaching. The efficient uniform-mixing and activating system is used to implement efficient uniform-mixing of ore particles and an activator, accelerates activation reaction through a micro-current electric field, and resolves metal minerals in a free ionic state, so as to rapidly improve leaching efficiency of the metal minerals. Finally, the conditioning and pressing dewatering system is used to physically and chemically condition and thicken mixed slurry material subjected to chemical leaching, and then perform high-pressure plate-frame pressing dewatering, to implement efficient solid-liquid separation. A water content of a mud cake is less than 35%, a size of the dry tailings residue is greatly reduced, tailings dry discharge is implemented, and tailings disposal cost is reduced. According to the efficient multiphase-flow graded-separation, concentration, and purification system for argillaceous sandstone uranium ore in the present disclosure, finally, four types of core material of coarse sand material, fine sand material, dry tailings residue and a high-concentration uranium ore leaching solution are formed through continuous work. Finally, efficient multiphase-flow graded-separation, concentration and purification of the argillaceous sandstone uranium ore are implemented, residue of element uranium in tailings is reduced, and an intensive extraction rate of uranium ore resources is improved. Key problems such as high mud content, unclassifiable leaching, low leaching rate, high residual uranium content in tailings and low utilization rate of uranium resources of the argillaceous sandstone uranium ore are solved.
3. The efficient multiphase-flow graded-separation, concentration, and purification system for argillaceous sandstone uranium ore in the present disclosure has a simple and clear process, modular design, an integrated skid-mounted structure, a small occupied area and a high space utilization rate.
4. According to the energy-gathering ultrasonic scrubbing device in the present disclosure, on one hand, a desliming effect is improved through the plurality of layers of reverse stirring blade structures. Specifically, the slurry is collected and compressed through a bell-mouth channel formed by the two adjacent layers of reverse stirring blade structures, to form a compressed multiphase-flow channel. Mutual friction power between the ore particles is increased, and strong scrubbing is achieved, such that clay particles with small particle diameters are crushed and scattered, and a fine particle clay layer wrapping the surfaces of the sand is destroyed. Moreover, a necking structure formed between two adjacent bell-mouth channels reduces a pressure at a center of a rear-end flow field during clockwise rotating and stirring, turbulence of the slurry is increased, and collision friction between the particles is continuously increased, such that efficient desliming of the argillaceous sandstone particles is implemented. On the other hand, ultrasonic kinetic energy provided by low-frequency and high-energy ultrasonic vibration and cavitation blasting kinetic energy are far greater than an interface adhesion force, to destroy the sand interfaces and separate the clay particles. Intensive mud-sand separation is implemented under combined action of high-pressure scrubbing and low-frequency and high-energy ultrasonic vibration in the multiphase-flow channel.
5. In the present disclosure, the energy-gathering vibration transmitting rod is designed into an energy-gathering structure, that is, the several spherical recesses are arranged at intervals in the axial direction of the energy-gathering vibration transmitting rod. When an end surface of the energy-gathering vibration gathering rod generates high-intensity axial vibration, spherical structures of the spherical recesses make contact with a slurry medium to generate a large number of cavitation nuclei with spherical centers as centers and then to generate a large cavitation intensity and energy, and perform divergent diffusion to finally implement similar transverse high-energy vibration, such that a vibration dimension and a density are increased. A great destructive force is applied to the surfaces of the particles. The clay particles are stripped. The mud content of the uranium ore is further reduced.
6. According to the pneumatic-energy miscible-flow uniform-mixing device provided in the present disclosure, the pneumatic energy is provided by a compressed high-pressure air jet flow. The high-pressure air jet flow is mixed with the mixed slurry in a limited space in a pipe to form miscible-flow material in a relatively low density. The miscible-flow material is rapidly conveyed under action of a continuous pneumatic push force and upward buoyancy, and sprayed and diffused at a high speed from a pipe outlet to drive pulp particles to form a high-speed turbulent flow and a mixed flow. The pulp particles and an activator are mixed rapidly. Mutual conversion between the pneumatic energy and mechanical kinetic energy of a miscible flow phase is completed to implement shaftless stirring and uniform mixing. The high-pressure air flow and the pulp are mixed to form the miscible-flow material. Kinetic energy exchange is carried out between air and slurry mixture. The air is mixed in the miscible flow as tiny compressed bubbles. The multiphase mixed flow slurry is sprayed out at a high speed from the pipe outlet of a pneumatic-energy miscible-flow uniform-mixing device along with pneumatic lifting kinetic energy. Large turbulent flow and vortex disturbance is formed in the stirring barrel and fully mixes the material. Moreover, the tiny compressed bubbles grow rapidly and break up to release energy to scatter cohesive particles, so as to increase contact areas of the particles. Thus efficient uniform-mixing of ore particles and the activator is implemented. A uniform mixing mode of shaftless stirring makes an overall structure simple. No mechanical transmission and high-speed rotation structure are provided. A uniform mixing structure has strong corrosion resistance. A failure rate of working in extreme acid and alkali and strong oxidation-reduction environments is greatly reduced. Comprehensive service life is prolonged. Operation and maintenance cost of a system apparatuses is reduced.

### BRIEF DESCRIPTION OF DRAWINGS

In order to describe the technical solutions in examples of the present disclosure or in the prior art more clearly, the accompanying drawings required for describing the examples or the prior art are briefly described below. Apparently, the accompanying drawings in the following description show some examples of the present disclosure. Those of ordinary skill in the art can still derive other accompanying drawings from these accompanying drawings without creative efforts.

FIG. 1 is a schematic structural diagram of an efficient multiphase-flow graded-separation, concentration, and purification system for argillaceous sandstone uranium ore according to the present disclosure;

FIG. 2 is a schematic structural diagram of an energy-gathering ultrasonic scrubbing device;

FIG. 3 is a schematic structural diagram of a reverse stirring system of the energy-gathering ultrasonic scrubbing device shown in FIG. 2;

FIG. 4 is a schematic structural diagram of an energy-gathering ultrasonic vibrator of the energy-gathering ultrasonic scrubbing device shown in FIG. 2;

FIG. 5 is a schematic diagram of a structure at B of the energy-gathering ultrasonic vibrator shown in FIG. 4;

FIG. 6 is a schematic structural diagram of an efficient uniform-mixing and activating system;

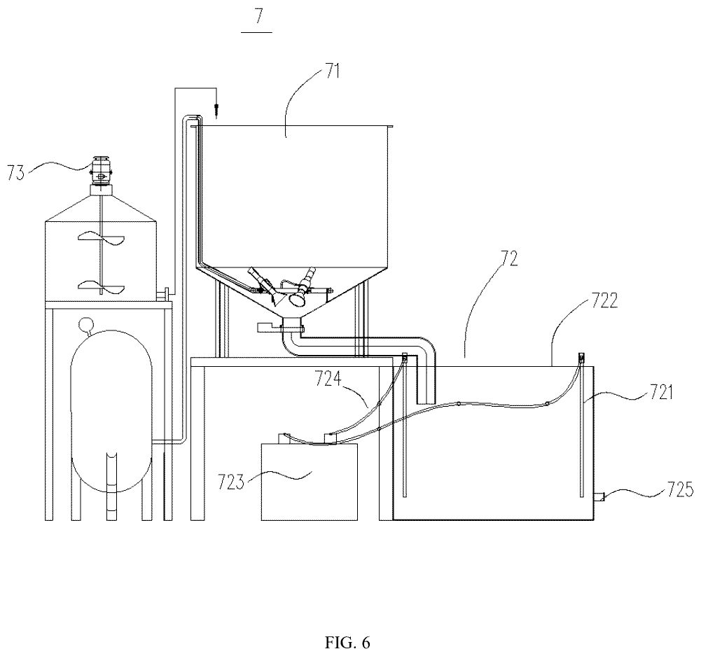

FIG. 7 is a schematic structural diagram of a pneumatic-energy miscible-flow uniform-mixing device of the efficient uniform-mixing and activating system shown in FIG. 6;

FIG. 8 is a schematic structural diagram of a miscible-flow uniform-mixing spraying device of the pneumatic-energy miscible-flow uniform-mixing device shown in FIG. 7;

FIG. 9 is a top view of a miscible-flow uniform-mixing spraying device of the pneumatic-energy miscible-flow uniform-mixing device shown in FIG. 7;

FIG. 10 is a schematic structural diagram of a miscible-flow uniform-mixing sprayer of the miscible-flow uniform-mixing spraying device shown in FIG. 9;

FIG. 11 is an exploded structural view of the miscible-flow uniform-mixing sprayer shown in FIG. 10; and

FIG. 12 is a structural section view of the miscible-flow uniform-mixing sprayer shown in FIG. 10.

In the figures: 1. hydraulic tossing washing and scattering pretreatment device; 11. large-material residue outlet; 12. pulp mixture discharge port;
2. high-frequency linear vibration grading device;
3. first-stage multiphase-flow swirling grading device;
4. energy-gathering ultrasonic scrubbing device; 41. scrubbing cylinder; 411. feed hopper; 412. overflow residue discharge pipe; 42. reverse stirring system; 421. rotating shaft; 422. first layer of blades; 423. second layer of blades; 424. third layer of blades; 425. fourth layer of blades; 43. power speed reducer; 44. energy-gathering ultrasonic vibrator; 441. ultrasonic transducer; 442. fixing flange; 443. energy-gathering vibration transmitting rod; 4431. spherical recess; 4432. end surface; 45. energy-gathering ultrasonic power supply; 46. slurry storage tank; 461. clean water pipe; 462. slurry uniform-mixing device; 47. cleaning discharge port; 48. high-pressure centrifugal slurry pump;
5. second-stage multiphase-flow swirling grading device;
6. high-frequency linear vibration dewatering device;
7. efficient uniform-mixing and activating system; 71. pneumatic-energy

miscible-flow uniform-mixing device; 711. uniform-mixing reaction kettle cylinder; 712. miscible-flow uniform-mixing spraying device; 7121. fixed bracket; 7122. miscible-flow uniform-mixing sprayer; 71221. miscible-flow sprayer; 71222. axial sleeve; 71223. slurry inlet pipe; 71224. air inlet connector; 71225. high-pressure air chamber; 71226. mixed-flow negative pressure area; 71227. multiphase mixed flow lifting area; 71228. diffusion flow outlet; 71229. slurry inlet channel; 7123. directional locking hinge; 7124. pneumatic-energy distributor; 7125. pipe clamp device; 7126. high-pressure air passage hose; 7127. air inlet; 713. slurry discharge pipe; 714. electromagnetic control valve; 715. air inlet pipe; 716. high-pressure air supply device; 72. micro-electrolysis activating device; 721. plate-type micro-electrolysis electrode; 722. micro-electrolysis activating reaction tank; 723. constant current power supply; 724. wire; 725. activated pulp outlet; 73. activator adding device;
8. conditioning and pressing dewatering system; 81. conditioning and condensing device; 82. high-pressure plunger grouting device; 83. high-pressure diaphragm filter press; 84. high-concentration uranium ore leaching solution collecting device;
91. waste water collecting device; 92. centrifugal slurry pump; 93. coarse sand material; 94. fine sand material; and 95. dry tailings residue.

### DETAILED DESCRIPTION OF THE INVENTION

In order to make the objectives, technical solutions, and advantages of the present disclosure clearer, the present disclosure is further described in detail below with reference to the accompanying drawings and an example. It should be understood that the specific example described herein is merely illustrative of the present disclosure and is not intended to limit the present disclosure.

It should be noted that the drawings provided in the example in the present disclosure are only schematic illustrations of the basic concept of the present disclosure. Thus the drawings only show the components related to the present disclosure rather than drawing according to the number, shape and size of the components in actual implementation. The shape, quantity and proportion of each component in actual implementation may be arbitrarily changed, and the component layout may be more complex.

In the present disclosure, it should also be noted that the orientation or position relations indicated by the terms “center,” “up,” “down,” “left,” “right,” “vertical,” “horizontal,” “inner,” “outer,” etc. are based on the orientation or position relations shown in the accompanying drawings. The terms are merely for facilitating the description of the present application and simplifying the description, rather than indicating or implying that the device or element referred to must have a particular orientation or be constructed and operated in a particular orientation. The terms therefore cannot be interpreted as limiting the present application. Moreover, the terms “first” and “second” are merely for description and distinguishing and cannot be interpreted as indicating or implying relative importance.

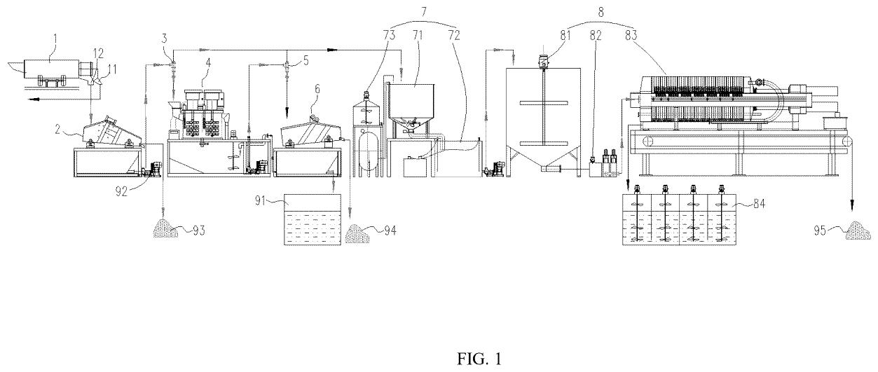

As shown in FIG. 1, an efficient multiphase-flow graded-separation concentration, purification system for argillaceous sandstone uranium ore is provided. The system is used for implementing intensive mud-sand separation of crushed argillaceous sandstone uranium ore and fine graded-separation of the material, and also used for performing efficient uniform-mixing and activating and deep and efficient dewatering for fine-particle argillaceous material, so as to fully improve fine separation efficiency of uranium resources. The system includes a hydraulic tossing washing and scattering pretreatment device 1, a high-frequency linear vibration grading device 2, a first-stage multiphase-flow swirling grading device 3, an energy-gathering ultrasonic scrubbing device 4, a second-stage multiphase-flow swirling grading device 5, a high-frequency linear vibration dewatering device 6, an efficient uniform-mixing and activating system 7 and a conditioning and pressing dewatering system 8.

Crushed mixed ore material enters the hydraulic tossing washing and scattering pretreatment device 1. Clean water is also injected for mixing and slurring. The hydraulic tossing washing and scattering pretreatment device 1 uniformly rolls to toss and move the material. Large agglomerated mixed ore material is fully scattered through a hydraulic tossing effect, most discrete particles and clay particles are separated through preliminary cleaning. A filtering particle diameter of the hydraulic tossing washing and scattering pretreatment device 1 is designed to be N1. In the example, N1=3 mm. Particles with a particle diameter greater than 3 mm are cleaning, then collected reversely from a large-material residue outlet 11 at a tail end, and crushed. Slurry with a particle diameter less than 3 mm is conveyed to the high-frequency linear vibration grading device 2 through a pulp mixture discharge port 12.

A function of the high-frequency linear vibration grading device 2 is to perform particle diameter graded-separation on the slurry material through high-frequency linear vibration sieving, so as to provide mixed material with less particle diameters for the next step. The slurry with a filtering particle diameter less than N1 falls directly onto a surface of a sieve plate of the high-frequency linear vibration grading device 2, and linearly vibrates with the sieve plate at a high frequency. Thus the material is graded rapidly. A sieving particle diameter of the high-frequency linear vibration grading device 2 is designed to be N2. In the example, N2=1 mm. A vibration frequency is designed to be 20 Hz to 25 Hz. Material grading can be implemented efficiently. Sand particles with a particle diameter greater than or equal to 1 mm are trapped on the surface of the sieve plate. A mud-water mixture with a particle diameter less than 1 mm passes through sieve holes and is collected into the slurry storage tank under the sieve plate. After being processed by the high-frequency linear vibration grading device 2, two kinds of material are formed. The oversized material is coarse sand material 93 with a particle diameter ranging from 1 mm to 3 mm. The coarse sand material has high permeability and a larger specific surface area and satisfies a heap leaching process, such that material with a particle diameter in this range is collected intensively and enters the heap leaching process separately. The undersized material is slurry material with a particle diameter less than 1 mm. The slurry material is conveyed into the first-stage multiphase-flow swirling grading device 3 through a centrifugal slurry pump 92 arranged at a lower end of the slurry storage tank, and provides tangential power of slurry inlet.

A function of the first-stage multiphase-flow swirling grading device 3 is to grade and separate the slurry material according to the particle diameter by virtue of the tangential power of slurry inlet at a high speed and an effect of centrifugal multiphase-flow swirling. The slurry material with a particle diameter less than 1 mm enters at a high speed from a slurry inlet of the first-stage multiphase-flow swirling grading device 3 and forms a large centrifugal swirling flow field. A grading median particle diameter of the first-stage multiphase-flow swirling grading device 3 is designed to be N3. In the example, N3=74 μm. In the centrifugal multiphase swirling flow field, larger-particle material (74 μm to 1 mm) moves downwards along an inner wall to form concentrated large-particle slurry material, and then is discharged from an underflow outlet at a low end of the first-stage multiphase-flow swirling grading device 3. This part of material belongs to the underflow mixed material with a high mud content. A large number of small-particle-diameter clay particles are attached to a surface of the material, and even sandstone uranium ore particles are wrapped in them. Further stripping and desliming are needed. The material enters the energy-gathering ultrasonic scrubbing device 4 for intensive desliming through pipe diversion. Fine-particle light material with a particle diameter less than or equal to 74 μm and a large amount of water overflow out along a central overflow port of the swirling flow field. This part of material mainly includes clay and fine ore powder material with a large specific surface area and poor permeability, and is suitable for chemical leaching. This part of material overflows to the efficient uniform-mixing and activating system 7 through the pipe and is subjected to activation and chemical leaching.

The mud-containing underflow mixed material generated by the underflow at the lower end of the first-stage multiphase-flow swirling grading device 3 enters the energy-gathering ultrasonic scrubbing device 4. The clay particles remaining on the surface of the sand are efficiently stripped and scattered through low-frequency and high-energy ultrasonic vibration and strong stirring. Thus mixed slurry with mud and sand relatively separated is obtained. The mixed slurry overflows to the slurry storage tank 46 below and is pumped into the second-stage multiphase-flow swirling grading device 5 through the centrifugal slurry pump 92.

The second-stage multiphase-flow swirling grading device 5 is used for further implementing particle diameter graded-separation. A grading median particle diameter of the second-stage multiphase-flow swirling grading device 5 is still designed to be N3. In the example, N3=74 μm. Clay particles less than or equal to 74 μm stripped by the energy-gathering ultrasonic scrubbing device 4 and a large amount of water are guided to the efficient uniform-mixing and activating system 7 along the central overflow port of the swirling flow field. Moreover, a particle diameter of underflow material in the swirling flow field is 74 μm to 1 mm. A surface of this part of sand material is clean, and a mud content is greatly reduced and is less than 3%, satisfying the requirements of heap leaching. This part of sand material is guided to the high-frequency linear vibration dewatering device 6.

The high-frequency linear vibration dewatering device 6 is designed in a high-frequency linear vibration sieving mode. In the example, the sieve holes of the sieve plate are designed to be 0.075 mm to 0.1 mm. A vibration frequency is designed to be 30 Hz to 35 Hz. Thus solid-liquid separation is implemented. Fine sand material 94 with a low water content (the water content is less than 30%) is formed and is subjected to centralized heap leaching. A large amount of water is collected into a water storage tank through a sieve mesh, then guided to a waste water collecting device 91, and processed for recycling.

In pre-sequence processes, fine-particle mud-water mixed powder less than or equal to 74 μm formed by overflowing of the first-stage multiphase-flow swirling grading device 3 and the second-stage multiphase-flow swirling grading device 5 enters the efficient uniform-mixing and activating system 7 for chemical leaching. Finally, element uranium in the ore powder is dissolved into a solution in a form of ions. The efficient uniform-mixing and activating system 7 includes a pneumatic-energy miscible-flow uniform-mixing device 71 and a micro-electrolysis activating device 72. The overflow ports of the first-stage multiphase-flow swirling grading device 3 and the second-stage multiphase-flow swirling grading device 5 are in communication with the pneumatic-energy miscible-flow uniform-mixing device 71. A discharge port of the pneumatic-energy miscible-flow uniform-mixing device 71 is in communication with the micro-electrolysis activating device 72. A discharge port of the micro-electrolysis activating device 72 is in communication with the conditioning and pressing dewatering system 8. After entering the efficient uniform-mixing and activating system 7, the material first passes through the pneumatic-energy miscible-flow uniform-mixing device 71. An activator adding device adds a chemical activator according to design parameters. The material and the chemical activator are efficiently and uniformly mixed fully through a miscible-flow uniform-mixing spraying device 712. Mixed material after uniform mixing flows automatically to the micro-electrolysis activating device 72. Under joint action of a micro-current and the activator, high efficiency activation is achieved. Metal element uranium in the fine ore powder is fully dissolved and leached.

The mixed slurry material after chemical leaching is pumped by the centrifugal slurry pump 92 to the conditioning and pressing dewatering system 8 for solid-liquid separation. The conditioning and pressing dewatering system 8 includes a conditioning and condensing device 81, a high-pressure plunger grouting device 82, a high-pressure diaphragm filter press 83, and a high-concentration uranium ore leaching solution collecting device 84. The mixed slurry material first passes through the conditioning and condensing device 81 for physical and chemical conditioning, to change deterwatering performance and simultaneously implement efficient condensing to improve a slurry inlet concentration. Thickened slurry is pump to the high-pressure diaphragm filter press 83 by the high-pressure plunger grouting device 82 for high-pressure mechanical deterwatering. A mud cake with a low water content (the water content of the mud cake is less than 35%), that is, dry tailings residue 95 is formed. Liquid separated by plate-frame filter pressing is a uranium-containing leaching solution, which is collected to the high-concentration uranium ore leaching solution collecting device 84 and stored into a uranium ore extraction process. The high-pressure diaphragm filter press 83 is provided with a clean water backwashing link, to greatly reduce remaining ionic metal uranium in the mud cake. Thus full extraction of the argillaceous sandstone uranium ore is implemented to improve a utilization rate of uranium ore resources.

According to the efficient multiphase-flow graded-separation, concentration, and purification system for argillaceous sandstone uranium ore in the present disclosure, finally, four types of core material of coarse sand material 93 (1 mm to 3 mm), fine sand material 94 (74 μm to 1 mm), dry tailings residue 95 (≤74 μm) and a high-concentration uranium ore leaching solution are formed through continuous work. Finally, efficient multiphase-flow graded-separation, concentration and purification of the argillaceous sandstone uranium ore are implemented, residue of element uranium in tailings is reduced, and an intensive extraction rate of uranium ore resources is improved. Key problems such as high mud content, unclassifiable leaching, low leaching rate, high residual uranium content in tailings and low utilization rate of uranium resources of the argillaceous sandstone uranium ore are solved.

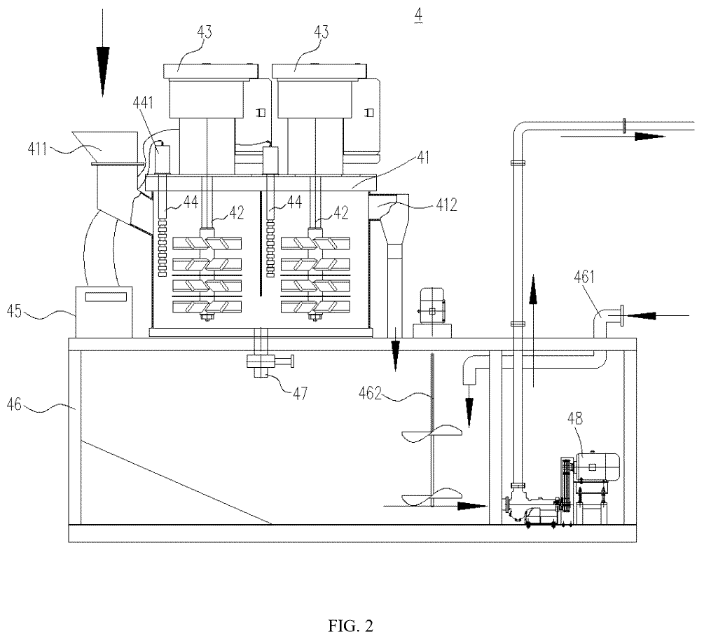

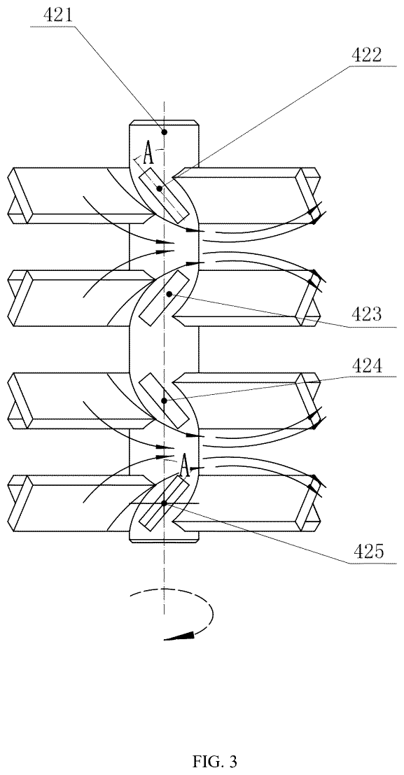

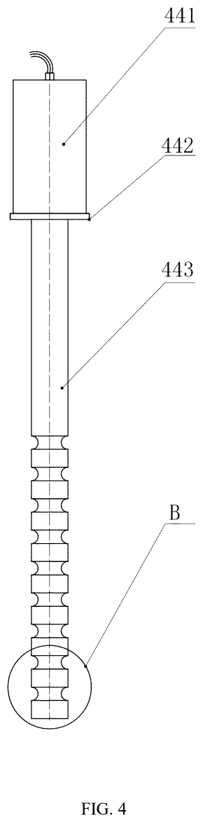

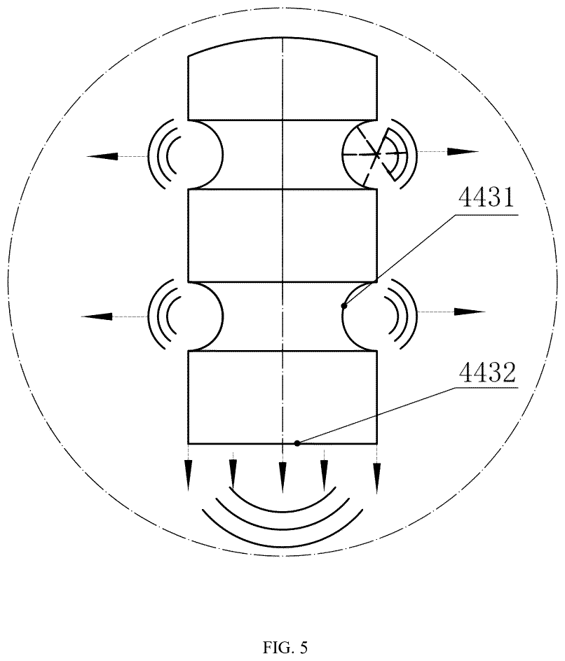

As shown in FIG. 2 to FIG. 5, the energy-gathering ultrasonic scrubbing device 4 includes a scrubbing cylinder 41, a reverse stirring system 42, an energy-gathering ultrasonic vibrator 44 and a slurry storage tank 46. One end wall of the scrubbing cylinder 41 is provided with a feed hopper 411. The other end wall is provided with an overflow residue discharge pipe 412. Thus a complete channel for feeding, filling, overflowing, and discharge guide is formed. The reverse stirring system 42 is arranged inside the scrubbing cylinder 41. The reverse stirring system 42 includes a rotating shaft 421 and at least four layers of reverse stirring blade structures arranged in an axial direction of the rotating shaft 421. The rotating shaft 421 is connected to a power speed reducer 43 arranged above the scrubbing cylinder 41 through a transmission shaft, and can rotate at a high speed under drive of the power speed reducer 43. Each layer of reverse stirring blade structure includes several blades arranged in a circumferential direction of the rotating shaft 421. Inclination directions of blades of two adjacent layers of reverse stirring blade structures relative to the rotating shaft 421 are opposite. The energy-gathering ultrasonic vibrator 44 includes an ultrasonic transducer 441 and an energy-gathering vibration transmitting rod 443. The ultrasonic transducer 441 is fixed outside the scrubbing cylinder 41 through a fixing flange 442. The energy-gathering vibration transmitting rod 443 is connected to the ultrasonic transducer 441 and located inside the scrubbing cylinder 41. The slurry storage tank 46 is arranged below the scrubbing cylinder 41 and serves as a load-bearing platform of the energy-gathering ultrasonic scrubbing device 4. The slurry storage tank 46 is connected to the overflow residue discharge pipe 412. A discharge port of the overflow residue discharge pipe 412 is directly guided to the slurry storage tank 46.

According to the energy-gathering ultrasonic scrubbing device 4 in the present disclosure, a compressed multiphase-flow channel is achieved through at least four layers of reverse stirring blade structures. Mutual friction power between the ore particles is increased, and strong scrubbing is achieved, such that clay particles with small particle diameters are crushed and scattered, and a fine particle clay layer wrapping the surfaces of the sand is destroyed. Moreover, ultrasonic kinetic energy provided by low-frequency and high-energy ultrasonic vibration and cavitation blasting kinetic energy are far greater than an interface adhesion force, to destroy a clay interface on the surface layer of the sand and strip the clay particles. Intensive mud-sand separation is implemented under combined action of high-pressure scrubbing and low-frequency and high-energy ultrasonic vibration in the multiphase-flow channel.

In the example, the reverse stirring system 42 includes four layers of reverse stirring blade structures uniformly arranged in the axial direction of the rotating shaft 421. Each layer of reverse stirring blade structure includes six blades uniformly arranged in a circumferential direction of the rotating shaft 421. Two layers of blades adjacent to each other from top to bottom are designed as opposite structures. During work, the reverse stirring system 42 rotates clockwise. An included angle A is formed between each layer of blades and an axis. For example, the first layer of blades 422 is inclined leftwards facing a water flow, and the second layer of blades 423 is inclined to rightwards. The layers of blades are arranged in sequence. Finally, the first layer of blades 422 and the second layer of blades 423, and the third layer of blades 424 and the fourth layer of blades 425 respectively form two bell-mouth channels. When the reverse stirring system 42 rotates clockwise, the bell-mouth channels collect and compress the slurry to form a compressed multiphase-flow channel. The mutual friction power between the ore particles is increased, and strong scrubbing is achieved, such that clay particles with small particle diameters are crushed and scattered, and a fine particle clay layer wrapping the surfaces of the sand is destroyed. Moreover, a necking structure is formed between the second layer of blades 423 and the third layer of blades 424. During clockwise rotating and stirring, a pressure in a rear-end flow field is reduced, turbulence of the slurry is increased, and collision friction between the particles is continued to increase, such that efficient desliming of argillaceous sandstone particles is implemented. In contrast, stirring blades of a conventional scrubbing machine only generate turbulence by disturbance, collision between particles is disordered, and friction intensity is limited.

As further optimization, in order to guarantee a collection and compression effect and a disturbance ability of the slurry, the included angle A between the blades of the reverse stirring blade structures and the rotating shaft 421 is designed not to exceed 45°.

As further optimization, the power speed reducer 43 is composed of an inverter motor and a speed reducer, and is used for provide power for the rotating shaft 421. A maximum torque is 1000 N·m, and a speed is designed to be 200 rpm to 300 rpm.

As further optimization, the energy-gathering ultrasonic scrubbing device 4 further includes an energy-gathering ultrasonic power supply 45 mounted on the scrubbing cylinder 41. The energy-gathering ultrasonic power supply 45 is electrically connected to the ultrasonic transducer 441. The energy-gathering ultrasonic power supply 45 provides power. The ultrasonic transducer 441 converts electrical energy into ultrasonic mechanical kinetic energy. The energy-gathering vibration transmitting rod 443 transmits low-frequency and high-energy vibration to generate a cavitation effect in a mud medium. The ultrasonic kinetic energy provided by the low-frequency and high-energy ultrasonic vibration and cavitation explosion kinetic energy are far greater than an interface adhesion force, to destroy a sand interface and strip the clay particles. A conventional ultrasonic cleaning machine typically uses a plate structure. That is, a plurality of small transducers are arranged into a vibrating plate to drive a side wall of a container to vibrate to generate ultrasonic waves. This usually shows insufficient vibration intensity and low effective kinetic energy under same power. Moreover, although a vibration surface of an ordinary cylindrical vibrator can produce high-intensity energy, the ordinary cylindrical vibrator only depends on a diameter end surface to do work, and an influence range is limited.

In the example, the energy-gathering vibration transmitting rod 443 is designed into an energy-gathering structure. That is, several spherical recesses 4431 are arranged at intervals in the axial direction of the energy-gathering vibration transmitting rod. When an end surface 4432 of the energy-gathering vibration gathering rod 443 generates high-intensity axial vibration, spherical structures of the spherical recesses 4431 make contact with a slurry medium to generate a large number of cavitation nuclei with spherical centers as centers and then to generate a large cavitation intensity and energy, and perform divergent diffusion to finally implement similar transverse high-energy vibration, such that a vibration dimension and a density are increased. A great destructive force is applied to the surfaces of the particles. The clay particles are stripped.

As further optimization, in the example, the energy-gathering ultrasonic power supply 45 and the energy-gathering ultrasonic vibrator 44 select industrial-grade low-frequency and high-energy parameters. The energy-gathering ultrasonic vibrator 44 has a frequency of 20 KHz to 25 KHz and an amplitude of 80 μm to 100 μm. A transmission capacity is high, cavitation intensity is high, and a high-efficiency vibration effect range may reach 300 mm to 400 mm of a three-dimensional space.

As further optimization, in the example, a cleaning discharge port 47 is arranged at the bottom of the scrubbing cylinder 41 as a shutdown unloading cleaning and draining channel. A gate valve in a normally closed state is arranged at the bottom of the scrubbing cylinder.

As further optimization, in the example, the slurry storage tank 46 is provided with a clean water pipe 461 for injecting clean water. The slurry storage tank 46 is further internally provided with a slurry uniform-mixing device 462. When a concentration of the slurry is too high, clean water needs to be added through a clean water pipe 461 fixed to a frame of the slurry storage tank 46, and is mixed uniformly by a slurry uniform-mixing device 462. A slurry discharge port and a high-pressure centrifugal slurry pump 48 are arranged at a bottom of the slurry storage tank 46. The slurry material is lifted and discharged through the high-pressure centrifugal slurry pump 48 and enters the next process.

As further optimization, the scrubbing cylinder 41 is internally provided with a single bin or a plurality of bins according to production capacity requirements. Each bin is provided with one reverse stirring system 42 and the energy-gathering ultrasonic vibrator 44. When the plurality of bins are provided, an interior of the cylinder is divided into the plurality of bins by arranging middle baffles. Communication channels are reserved at bottoms or tops of the middle baffles for communication between the bins. The communication channels are alternately arranged in a vertical direction to guarantee that the material fully passes through a stirring area and the material is uniformly fed from a first bin and discharged from a tail bin by overflowing. The scrubbing cylinder 41 is divided into a plurality of bins, such that slurry scrubbing intensity in a single bin can be increased on one hand, and bin bottoms are in communication with each other to increase a flow path and scrubbing time of the mixed pulp material. The scrubbing quality can be improved. In the example, the interior of the scrubbing cylinder 41 is divided into two bins, whose bottoms are connected.

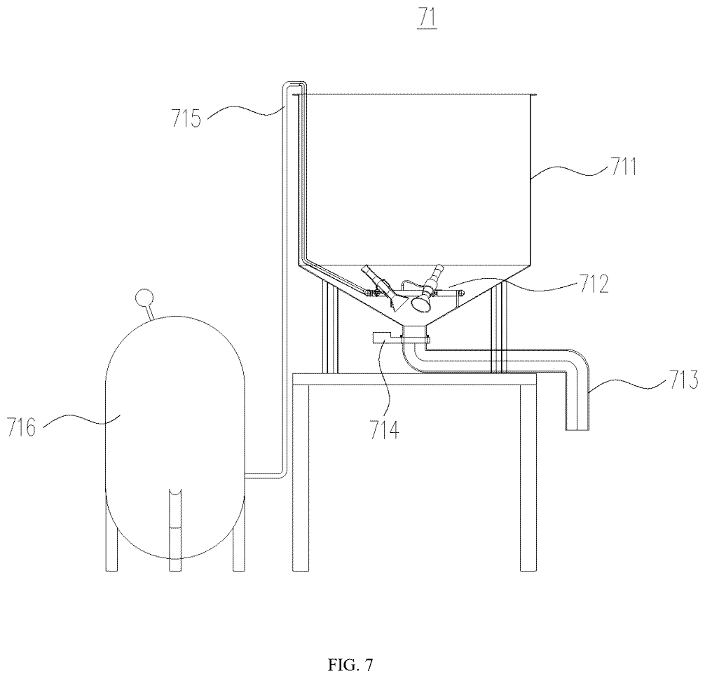

As shown in FIG. 7, the efficient uniform-mixing and activating system 7 includes a pneumatic-energy miscible-flow uniform-mixing device 71, a micro-electrolysis activating device 72 and an activator adding device 73.

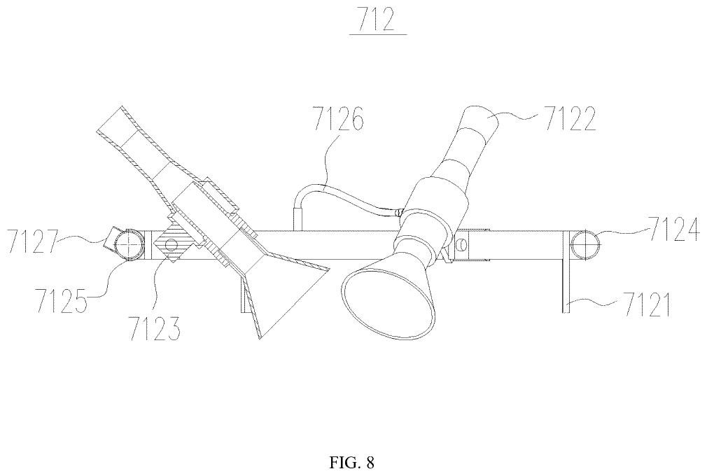

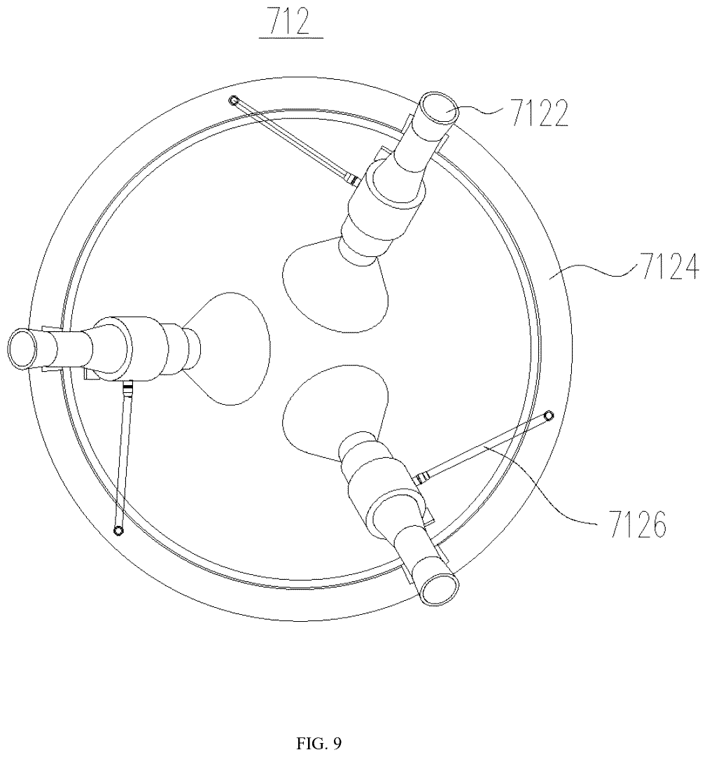

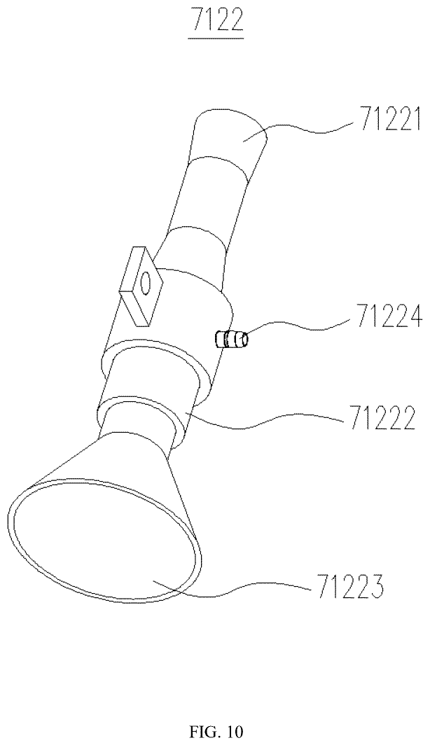

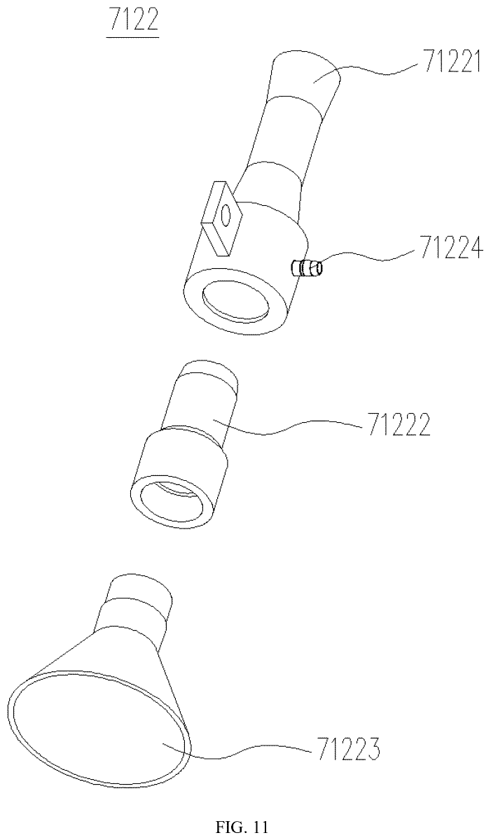

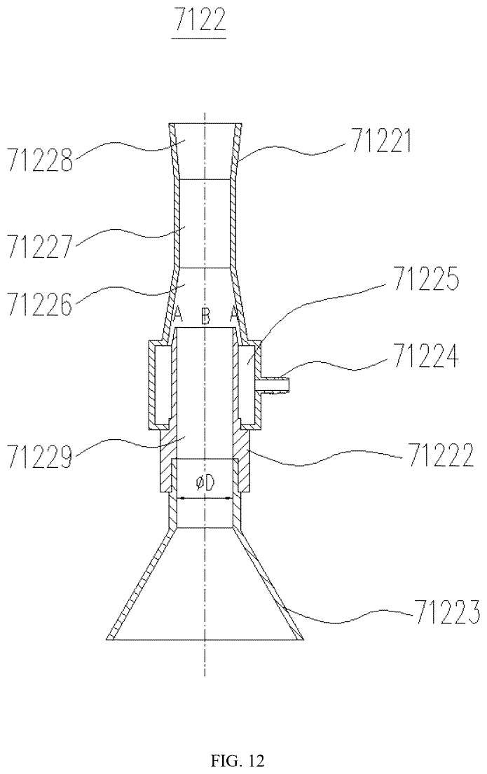

As shown in FIG. 8 to FIG. 12, the pneumatic-energy miscible-flow uniform-mixing device 71 includes a uniform-mixing reaction kettle cylinder 711, a miscible-flow uniform-mixing spraying device 712 and a high-pressure air supply device 716. The miscible-flow uniform-mixing spraying device 712 includes a fixed bracket 7121, a miscible-flow uniform-mixing sprayer 7122 and a pneumatic-energy distributor 7124. The fixed bracket 7121 is fixedly mounted at a bottom of the uniform-mixing reaction kettle cylinder 711. The miscible-flow uniform-mixing sprayer 7122 and the pneumatic-energy distributor 7124 are mounted on the fixed bracket 7121 separately. An air inlet 7127 of the pneumatic-energy distributor 7124 is connected to the high-pressure air supply device 716 through an air inlet pipe 715. An air outlet of the pneumatic-energy distributor 7124 is connected to the miscible-flow uniform-mixing sprayer 7122 through high-pressure air passage hoses 7126. High-pressure air generated by the high-pressure air supply device 716 enters the pneumatic-energy distributor 7124 through the air inlet pipe 715 and then enters the miscible-flow uniform-mixing sprayer 7122. Pneumatic energy is provided by a compressed high-pressure air jet flow in the miscible-flow uniform-mixing sprayer 7122. The high-pressure air jet flow makes contact and gets mixed with mixed slurry in a limited space in a pipe to form miscible-flow material in a relatively low density. The miscible-flow material is rapidly conveyed under action of a continuous pneumatic push force and upward buoyancy, and sprayed and diffused at a high speed from a pipe outlet to drive pulp particles to form a high-speed turbulent flow and mixed flow. The pulp particles and an activator are mixed rapidly. Mutual conversion between the pneumatic energy and mechanical kinetic energy of a miscible flow phase is completed to implement shaftless stirring and uniform mixing. A discharge port at a bottom end of the uniform-mixing reaction kettle cylinder 711 is connected to a slurry discharge pipe 713. An electromagnetic control valve 714 is arranged on the slurry discharge pipe 713.

The miscible-flow uniform-mixing sprayer 7122 is mounted on the fixed bracket 7121 through a directional locking hinge 7123. The directional locking hinge 7123 may adjust an angle of the miscible-flow uniform-mixing sprayer 7122 and has a locking function. In the example, three miscible-flow uniform-mixing sprayers 7122 are uniformly arranged in a circumferential direction of the fixed bracket 7121. The pneumatic-energy distributor 7124 is fixed by a pipe clamp device 7125 arranged on the fixed bracket 7121. Three air supply ports are arranged on the pneumatic-energy distributor 7124 and are respectively connected to the three miscible-flow uniform-mixing sprayers 7122 through high-pressure air passage hoses 7126. The fixed bracket 7121 is fixed at the bottom of the uniform-mixing reaction kettle cylinder 711 by anti-corrosion bolts or welding.

The miscible-flow uniform-mixing sprayer 7122 is a core component of the pneumatic-energy miscible-flow uniform-mixing device 71, and includes a miscible-flow sprayer 71221, an axial sleeve 71222 and a slurry inlet pipe 71223 that are coaxially arranged and are in communication with each other. An upper end of the axial sleeve 71222 is fixedly connected to the miscible-flow sprayer 71221 through external threads. A gap is reserved between an inner wall of a lower end of the miscible-flow sprayer 71221 and an outer wall of an upper end of the axial sleeve 71222 to form a high-pressure air chamber 71225. The high-pressure air chamber 71225 is provided with an air inlet connector 71224 for being connected to an air outlet of the pneumatic-energy distributor 7124. An area of the miscible-flow sprayer 71221 located above the axial sleeve 71222 is sequentially provided with a mixed-flow negative pressure area 71226, a multiphase mixed flow lifting area 71227 and a diffusion flow outlet 71228 from bottom to top. The mixed-flow negative pressure area 71226 is in communication with the high-pressure air chamber 71225 through a gap channel. A lower end of the axial sleeve 71222 is fixedly connected to the slurry inlet pipe 71223 through internal threads. A slurry inlet channel 71229 is formed inside the slurry inlet pipe 71223 and the axial sleeve 71222.

As further optimization, an inner diameter of the mixed-flow negative pressure area 71226 of the miscible-flow sprayer 71221 is gradually reduced from bottom to top, which has a desirable compression effect on a medium with a high flow rate. Thus a pressure in a transition area from the mixed-flow negative pressure area 71226 to the multiphase mixed flow lifting area 71227 is increased, which is conducive to mixing of high-pressure air and the slurry to form high-speed air-liquid-solid multiphase mixed flow material. An inner diameter of the multiphase mixed flow lifting area 71227 is kept constant from bottom to top, such that uniform mixing time and path of the multiphase mixed flow material are increased. An inner diameter of a diffusion flow outlet 71228 is gradually increased from bottom to top, which is beneficial to high-speed injection diffusion of the multiphase mixed flow material.

As further optimization, the slurry inlet pipe 71223 is of a horn structure with a lower portion thicker than an upper portion. The structure is beneficial to collection and feeding of the slurry, A diameter D of an upper end of the slurry inlet pipe 71223 is equal to an inner diameter of the axial sleeve 71222.

A working principle of the miscible-flow uniform-mixing sprayer 7122 is as follows:

High-pressure air enters the high-pressure air chamber 71225 from the air inlet connector 71224. The high-pressure air chamber 71225 is in communication with the mixed-flow negative pressure area 71226 through a gap channel A with a small section. The high-pressure air enters the mixed-flow negative pressure area 71226 through the gap channel A in a form of a high-speed jet flow, and is mixed with the slurry in the chamber to form an air-liquid-solid multiphase mixed flow. Compressed air is mixed with the slurry in a form of larger bubbles at first, and continues to enter the multiphase mixed flow lifting area 71227. In this case, a diameter of the pipe is reduced. A local pressure is increased. Kinetic energy exchange is carried out between air and slurry mixture. A diameter of bubbles of the compressed air is reduced. The compressed air is mixed in the miscible flow as tiny compressed bubbles. A density of the multiphase mixed flow is reduced. An upward lifting pressing force is generated by a newly formed multiphase mixed flow. Under composite action of pneumatic lifting kinetic energy, a higher flow rate is formed. The multiphase mixed flow continues to enter the diffusion flow outlet 71228 to spray and diffuse into external slurry at a high speed.

Moreover, when the high-pressure air enters the mixed-flow negative pressure area 71226 through the gap channel A in a form of a high-speed jet flow, a negative pressure is formed in a transition area B at an intersection with an upper end of the slurry inlet channel 71229. Under action of an internal and external pressure difference, the slurry in the slurry inlet channel 71229 is continuously lifted to participate in mixed-flow uniform mixing. Then a large amount of mixed slurry is sucked into circulation through the slurry inlet pipe 71223. When a flow rate of the slurry at an inlet is large enough, a large amount of solid particles are entrained for mixed flow circulation. The multiphase mixed flow slurry can be sprayed out at a high speed from the pipe outlet of the miscible-flow uniform-mixing sprayer 7122 along with pneumatic lifting kinetic energy. Large turbulent flow and vortex disturbance is formed in the uniform-mixing reaction kettle cylinder 711 and fully mixes the material.

In order to guarantee suction and lifting mixing ability and efficiency of the miscible-flow uniform-mixing sprayer 7122, it is necessary to guarantee an enough slurry inlet flow rate. Under the condition that the kinetic energy of the compressed air is fixed, diameters of the slurry inlet channel 71229 and the slurry inlet pipe 71223 are a core of the entire structure. The diameters influence a structure size of the entire apparatus, and also influence an overall mixed flow rate and production capacity of the apparatus. Accordingly, in a case of determining a total mixed flow volume, the diameter D of the slurry inlet pipe 71223 directly influences the production capacity and a size of an entire equipment component.

Design of a diameter D parameter of the slurry inlet pipe 71223 of the present disclosure is calculated by formula (1), formula (1) is:

$$D \leq \sqrt{\frac{{Q}_{m}}{0.75 V}} \qquad ( 1 )$$

where, Qₘ is a designed slurry flow rate with a value designed in advance and generally a measured value through an actual working condition test; and V is a lifting flow rate.

According to data model design, in order to guarantee that particles in the slurry can be efficiently lifted through a suction port, negative-pressure suction power is greater than settlement of the particles, that is, a lifting flow rate V in the pipe is greater than a settling rate ω of pulp particles. In order to guarantee smooth lifting and uniform-mixing of ore particles within a particle range, the lifting flow rate V is sufficient to be greater than a maximum value ωₘₐₓ of the settling rate ω of the pulp particles. The maximum value is calculated according to formula (2):

$$V > 4 {ω}_{max} . \qquad ( 2 )$$

According to experience and related basic research theory basis, assuming that the pulp particles are spherical, in a process of particle descent, when a resistance and gravity are balanced, the particles are falling at a constant speed. A value of the settling rate ω of the pulp particles may be calculated according to formula (3):

$$ω = \sqrt{\frac{4}{3 {C}_{d}}} \cdot \sqrt{\frac{{ρ}_{s} - ρ}{ρ} gd} \qquad ( 3 )$$

where, Cd is a settling resistance coefficient of mud-sand particles, ρₛ is a density of the mud-sand particles, and ρ is a fluid density; and d is a spherical diameter of the mud-sand particles, and g is an acceleration of gravity.

In an actual working condition, a shape of the pulp particles is not standard spherical, such that parameters need to be further introduced for revision. Combined with a large number of experimental data and empirical parameters, the settling resistance coefficient Cd of the mud-sand particles is expressed as formula (4):

$${C}_{d} = \frac{24}{Re} [ 1 + \frac{3 Re}{4 ( 40 - 31 {e}^{- 0.0064 Re} )} ] \qquad ( 4 )$$

where, Re is a Reynolds number.

Thus formula (4) is substituted into formula (3), and formula (5) is obtained through empirical parameter optimization:

$$ω = \sqrt{{( {C}_{1} \frac{μ}{d} )}^{2} + {C}_{2} ( \frac{{ρ}_{s} - ρ}{ρ} ) gd} - {C}_{1} ( \frac{μ}{d} ) \qquad ( 5 )$$

where,

$${C}_{1} = \frac{2}{3} ( 40 - 31 {e}^{- 0.0061 Re} ) , {C}_{2} = \frac{1}{9} {C}_{1} ,$$

and μ is a kinematic viscosity coefficient of liquid. Combined with a data experience summary, parameter design values C₁=13.95 and C₂=1.09 in the example; and μ may be selected according to experience.

According to prototype experiment verification, compared with a stirring effect of stirring blades, the present disclosure reduces effective time of overall circulation uniform-mixing of the pneumatic-energy miscible-flow uniform-mixing device 71 by 50%, so as to effectively improve quality and efficiency of miscible-flow uniform-mixing.

With further reference to FIG. 7, the micro-electrolysis activating device 72 includes plate-type micro-electrolysis electrodes 721, a micro-electrolysis activating reaction tank 722, and constant current power supply 723. The plate-type micro-electrolysis electrodes 721 are fixed on two ends of an inner side of the micro-electrolysis activating reaction tank 722 through insulating material. The constant current power supply 723 is arranged on an outer side of the micro-electrolysis activating reaction tank 722 and connected to the plate-type micro-electrolysis electrodes 721 through wires. A stable electric field is formed. According to experimental verification and summary of working conditions, it is appropriate to set a voltage of micro-electric field to 36 V. A bottom of the micro-electrolysis activating reaction tank 722 is provided with an activated pulp outlet 725. A bottom end of each plate-type micro-electrolysis electrode 721 is separated from the bottom of the micro-electrolysis activating reaction tank 722 by a distance, to guarantee normal flowing and discharge of the pulp material.

A working principle of the efficient uniform-mixing and activating system 7 is as follows:

After crushing and grinding, the homogeneous pulp and the activator are separately added from the upper feed port of the uniform-mixing reaction kettle cylinder 711 of the pneumatic-energy miscible-flow uniform-mixing device 71 in a pipe conveying manner until a liquid level of the mixed slurry reaches one third of a whole volume. The miscible-flow uniform-mixing spraying device 712 is fully submerged by the slurry. Then an automatic control system 73 starts the high-pressure air supply device 716 to supply air.

In the miscible-flow uniform-mixing spraying device 712, the pneumatic energy is provided by a compressed high-pressure air jet flow. The high-pressure air jet flow makes contact and gets mixed with the mixed slurry in a limited space in a pipe to form miscible-flow material in a relatively low density. The miscible-flow material is rapidly conveyed under action of a continuous pneumatic push force and upward buoyancy, and sprayed and diffused at a high speed from a pipe outlet to drive pulp particles to form a high-speed turbulent flow and mixed flow. The pulp particles and an activator are mixed rapidly to implement shaftless stirring and uniform mixing. Moreover, a negative pressure is formed at an intersection of a high-pressure air injection port and a lower feeding pipe. The slurry in the pipe is continuously lifted to participate in mixed-flow uniform mixing under the action of internal and external pressure difference. The high-pressure air flow and the pulp are mixed to form the miscible-flow material. Kinetic energy exchange is carried out between air and slurry mixture. The air is mixed in the miscible flow as tiny compressed bubbles. The multiphase mixed flow slurry is sprayed out at a high speed from the pipe outlet of a pneumatic-energy miscible-flow uniform-mixing device along with pneumatic lifting kinetic energy. Large turbulent flow and vortex disturbance is formed in the uniform-mixing reaction kettle cylinder 711 and fully mixes the material. Moreover, the tiny compressed bubbles grow rapidly and break up to release energy to scatter cohesive particles, so as to increase contact areas of the particles. Thus efficient uniform-mixing of ore particles and the activator is implemented. When the flow rate in the pipe is large enough, the slurry carries particles and more mud and sand with larger specific gravity into the mixed flow circulation at the inlet, so as to avoid deposition and clogging of solid particles due to a too high settling rate.

After the pulp and the activator are uniformly mixed, the activator and ore particles need to fully react through aging for certain time. Metal minerals are resolved in a free ionic state. In the present disclosure, the micro-electrolysis activating device 72 is additionally arranged. The activation reaction is accelerated through a micro-current electric field. Leaching efficiency of the metal minerals is rapidly improved. After mixed slurry material is uniformly mixed in the pneumatic-energy miscible-flow uniform-mixing device 71, the electromagnetic control valve 714 is started and opened, and the mixed slurry material enters the micro-electrolysis activating device 72 through the slurry discharge pipe 713. When the micro-electrolysis activating reaction tank 722 is filled with the uniformly mixed pulp material, the activation reaction is accelerated under the micro-current electric field. The leaching efficiency of the metal minerals is rapidly improved. The metal minerals are resolved in a free ion state. Finally, the activated mixed material is discharged into the next process flow through the activated pulp discharge port. Finally, the high-precision extreme ore separation of high-value metals is implemented.

The efficient uniform-mixing and activating system 7 improves the turbulence and mixed flow power between the pulp and the activator, strengthens the turbulence and vortex disturbance of the mixed slurry, increases micro-electrolysis efficiency of the activation reaction, improves the uniform-mixing and activation efficiency and the chemical leaching efficiency, and is an integrated system with functions of efficient uniform-mixing and activating for pulp under extreme environments.

It should be noted that, according to implementation requirements, each step/component described in the present application may be split into more steps/components, or two or more steps/components or some operations of steps/components may be combined into a new step/component, so as to achieve the objectives of the present disclosure.

In the examples, the numbers of all the above steps do not mean an order of execution. The order of execution of each process should be determined by its function and internal logic, and should not impose any limitation on the implementation processes of the examples of the present application.

It should be understood that modifications and variations will occur to those of ordinary skill in the art in light of the foregoing description. All such modifications and variations are intended to fall within the scope of the appended claims of the present disclosure.

What is claimed is:

1. A multiphase-flow graded-separation, concentration and purification system for argillaceous sandstone uranium ore, comprising a hydraulic tossing washing and scattering pretreatment device, a high-frequency linear vibration grading device, a first-stage multiphase-flow swirling grading device, an energy-gathering ultrasonic scrubbing device, a second-stage multiphase-flow swirling grading device, a high-frequency linear vibration dewatering device, an efficient uniform-mixing and activating system and a conditioning and pressing dewatering system; wherein
a discharge port of the hydraulic tossing washing and scattering pretreatment device is in communication with a feed port of the high-frequency linear vibration grading device, a filtering particle diameter of the hydraulic tossing washing and scattering pretreatment device is designed to be N1, and slurry with a particle diameter less than N1 is conveyed to the high-frequency linear vibration grading device;
a discharge port of the high-frequency linear vibration grading device is in communication with a feed port of the first-stage multiphase-flow swirling grading device, a sieving particle diameter of the high-frequency linear vibration grading device is designed to be N2, N2<N1, and material with a particle diameter less than N2 is conveyed to the first-stage multiphase-flow swirling grading device;
a grading median particle diameter of the first-stage multiphase-flow swirling grading device is designed to be N3, N3<N2, material with a particle diameter ranging from N3 to N2 is discharged from an outlet at a lower end and guided into the energy-gathering ultrasonic scrubbing device, and fine-particle light material with a particle diameter less than or equal to N3 and a large amount of water are guided to the efficient uniform-mixing and activating system along a central overflow port of a swirling flow field;
the energy-gathering ultrasonic scrubbing device is configured for stripping and scattering remaining clay particles covering surfaces of sand, to separate mud from the sand, and a discharge port of the energy-gathering ultrasonic scrubbing device is in communication with a feed port of the second-stage multiphase-flow swirling grading device;
a grading median particle diameter of the second-stage multiphase-flow swirling grading device is designed to be N3, the clay particles having a particle diameter less than or equal to N3 and stripped by the energy-gathering ultrasonic scrubbing device and a large amount of water are guided to the efficient uniform-mixing and activating system along the central overflow port of the swirling flow field, and sand material having a particle diameter ranging from N3 to N2 and formed through mud-sand grading is guided to the high-frequency linear vibration dewatering device;
the efficient uniform-mixing and activating system comprises a pneumatic-energy miscible-flow uniform-mixing device and a micro-electrolysis activating device, overflow ports of the first-stage multiphase-flow swirling grading device and the second-stage multiphase-flow swirling grading device are in communication with the pneumatic-energy miscible-flow uniform-mixing device, a discharge port of the pneumatic-energy miscible-flow uniform-mixing device is in communication with the micro-electrolysis activating device, and a discharge port of the micro-electrolysis activating device is in communication with the conditioning and pressing dewatering system; and
the conditioning and pressing dewatering system is configured for physically and chemically conditioning and condensing mixed slurry material subjected to chemical leaching, and then performing high-pressure plate-frame pressing dewatering, to implement solid-liquid separation.

2. The multiphase-flow graded-separation, concentration and purification system according to claim 1, wherein the energy-gathering ultrasonic scrubbing device comprises a scrubbing cylinder, a reverse stirring system, an energy-gathering ultrasonic vibrator and a slurry storage tank; the scrubbing cylinder is provided with a feed hopper and an overflow residue discharge pipe; the reverse stirring system is arranged in the scrubbing cylinder and comprises a rotating shaft and at least four layers of reverse stirring blade structures arranged in an axial direction of the rotating shaft, each layer of reverse stirring blade structure comprises several blades arranged in a circumferential direction of the rotating shaft, and inclination directions of blades of two adjacent layers of reverse stirring blade structures relative to the rotating shaft are opposite; the energy-gathering ultrasonic vibrator comprises an ultrasonic transducer and an energy-gathering vibration transmitting rod, the ultrasonic transducer is fixed outside the scrubbing cylinder, and the energy-gathering vibration transmitting rod is connected to the ultrasonic transducer and located inside the scrubbing cylinder; and the slurry storage tank is connected to the overflow residue discharge pipe, and a discharge port of the overflow residue discharge pipe is directly guided to the slurry storage tank.

3. The multiphase-flow graded-separation, concentration and purification system according to claim 2, wherein an included angle between each of the several blades of the reverse stirring blade structures and the rotating shaft does not exceed 45°.

4. The multiphase-flow graded-separation, concentration and purification system according to claim 2, wherein the energy-gathering vibration transmitting rod is provided with several spherical recesses at intervals in an axial direction of the energy-gathering vibration transmitting rod.

5. The multiphase-flow graded-separation, concentration and purification system according to claim 2, wherein the energy-gathering ultrasonic vibrator has a frequency of 20 KHz to 25 KHz and an amplitude of 80 μm to 100 μm.

6. The multiphase-flow graded-separation, concentration and purification system according to claim 2, wherein the slurry storage tank is arranged at a bottom of the scrubbing cylinder, a cleaning discharge port is arranged at the bottom of the scrubbing cylinder as a shutdown discharge cleaning and draining channel, and a gate valve in a normally closed state is arranged at the bottom of the scrubbing cylinder.

7. The multiphase-flow graded-separation, concentration and purification system according to claim 2, wherein the slurry storage tank is provided with a clean water pipe for injecting clean water; the slurry storage tank is further internally provided with a slurry uniform-mixing device; and a slurry discharge port and a high-pressure centrifugal slurry pump are arranged at a bottom of the slurry storage tank, and the slurry material is lifted and discharged through the high-pressure centrifugal slurry pump.

8. The multiphase-flow graded-separation, concentration and purification system according to claim 2, wherein the scrubbing cylinder is internally provided with a single bin or a plurality of bins according to production capacity requirements, and each bin is provided with one reverse stirring system and the energy-gathering ultrasonic vibrator;
and when the plurality of bins are provided, an interior of the cylinder is divided into the plurality of bins by arranging middle baffles, communication channels are reserved at bottoms or tops of the middle baffles for communication between the bins, and the communication channels are alternately arranged in a vertical direction to guarantee that the material fully passes through a stirring area.

9. The multiphase-flow graded-separation, concentration and purification system according to claim 1, wherein the pneumatic-energy miscible-flow uniform-mixing device comprises a uniform-mixing reaction kettle cylinder, a miscible-flow uniform-mixing spraying device and a high-pressure air supply device; and the miscible-flow uniform-mixing spraying device comprises a fixed bracket, a miscible-flow uniform-mixing sprayer and a pneumatic-energy distributor, wherein the fixed bracket is fixedly mounted at a bottom of the uniform-mixing reaction kettle cylinder, the miscible-flow uniform-mixing sprayer and the pneumatic-energy distributor are mounted on the fixed bracket separately, an air inlet of the pneumatic-energy distributor is connected to the high-pressure air supply device, an air outlet of the pneumatic-energy distributor is connected to the miscible-flow uniform-mixing sprayer, high-pressure air generated by the high-pressure air supply device enters the miscible-flow uniform-mixing sprayer through the pneumatic-energy distributor, pneumatic energy is provided by a high-pressure air jet flow in the miscible-flow uniform-mixing sprayer, the high-pressure air jet flow makes contact and gets mixed with mixed slurry in a limited space in a pipe to form miscible-flow material in a relatively low density, the miscible-flow material is rapidly conveyed under action of a continuous pneumatic push force and upward buoyancy, and sprayed and diffused at a high speed from a pipe outlet to drive pulp particles to form a high-speed turbulent flow and mixed flow, the pulp particles and an activator are mixed rapidly, and mutual conversion between the pneumatic energy and mechanical kinetic energy of a miscible flow phase is completed to implement shaftless stirring and uniform mixing.

10. The multiphase-flow graded-separation, concentration and purification system according to claim 9, wherein the miscible-flow uniform-mixing sprayer comprises a miscible-flow sprayer, an axial sleeve and a slurry inlet pipe that are coaxially arranged and are in communication with each other; an upper end of the axial sleeve is fixedly connected to the miscible-flow sprayer, a gap is reserved between an inner wall of a lower end of the miscible-flow sprayer and an outer wall of the upper end of the axial sleeve to form a high-pressure air chamber, and the high-pressure air chamber is provided with an air inlet connector for being connected to the air outlet of the pneumatic-energy distributor; an area of the miscible-flow sprayer located above the axial sleeve is sequentially provided with a mixed-flow negative pressure area, a multiphase mixed flow lifting area and a diffusion flow outlet from bottom to top, and the mixed-flow negative pressure area is in communication with the high-pressure air chamber through a gap channel; and a lower end of the axial sleeve is fixedly connected to the slurry inlet pipe, and a slurry inlet channel is formed inside the slurry inlet pipe and the axial sleeve.

11. The multiphase-flow graded-separation, concentration and purification system according to claim 10, wherein the slurry inlet pipe is of a horn structure with a lower portion thicker than an upper portion, and a diameter D of an upper end of the slurry inlet pipe is equal to an inner diameter of the axial sleeve.

12. The multiphase-flow graded-separation, concentration and purification system according to claim 11, wherein the diameter D of the upper end of the slurry inlet pipe satisfies formula (1):
$$D \leq \sqrt{\frac{{Q}_{m}}{0.75 V}} \qquad ( 1 )$$
wherein, Qₘ is a designed slurry flow rate with a value designed in advance; and V is a lifting flow rate.

13. The multiphase-flow graded-separation, concentration and purification system according to claim 12, wherein the lifting flow rate V is calculated according to formula (2):
$$V > 4 {ω}_{max} \qquad ( 2 )$$
wherein, ωₘₐₓ is a maximum value of a settling rate ω of the pulp particles, and the settling rate ω of the pulp particles is calculated according to formula (5):
$$ω = \sqrt{{( {C}_{1} \frac{μ}{d} )}^{2} + {C}_{2} ( \frac{{ρ}_{s} - ρ}{ρ} ) gd} - {C}_{1} ( \frac{μ}{d} ) \qquad ( 5 )$$
$${C}_{1} = \frac{2}{3} ( 40 - 31 {e}^{- 0.0061 Re} ) ,$$
wherein, Re is a Reynolds number,
$${C}_{2} = \frac{1}{9} {C}_{1} ,$$
ρₛ is a density of mud-sand particles, ρ is a fluid density, d is a spherical diameter of the mud-sand particles, and μ is a kinematic viscosity coefficient of liquid.

14. The multiphase-flow graded-separation, concentration and purification system according to claim 10, wherein an inner diameter of the mixed-flow negative pressure area of the miscible-flow sprayer is gradually reduced from bottom to top, an inner diameter of the multiphase mixed flow lifting area is kept constant from bottom to top, and an inner diameter of the diffusion flow outlet is gradually increased from bottom to top.

15. The multiphase-flow graded-separation, concentration and purification system according to claim 1, wherein the micro-electrolysis activating device comprises plate-type micro-electrolysis electrodes, a micro-electrolysis activating reaction tank and a constant current power supply; and the plate-type micro-electrolysis electrodes are fixed on two ends of an inner side of the micro-electrolysis activating reaction tank through insulating material, and the constant current power supply is arranged on an outer side of the micro-electrolysis activating reaction tank and connected to the plate-type micro-electrolysis electrodes through wires.

16. The multiphase-flow graded-separation, concentration and purification system according to claim 1, wherein the conditioning and pressing dewatering system comprises a conditioning and condensing device, a high-pressure plunger grouting device, a high-pressure diaphragm filter press and a high-concentration uranium ore leaching solution collecting device, a feed port of the conditioning and condensing device is in communication with a discharge port of the micro-electrolysis activating device, a discharge port of the conditioning and condensing device is in communication with a feed port of the high-pressure diaphragm filter press through the high-pressure plunger grouting device, and the high-concentration uranium ore leaching solution collecting device is used for collecting a high-concentration uranium ore leaching solution from the high-pressure diaphragm filter press.
